(19) United States
(12) Patent Application Publication
(10) Pub. No.: US 2026/0195930 A1
(43) Pub. Date: Jul. 9, 2026

(54) Prompt Element Generation for use as Input in Generative Models

(71) Applicant: Google LLC, Mountain View, CA (US)

(72) Inventors: Abhishek Shrivastava, San Jose, CA (US); Hinali Naimish Marfatia, Milpitas, CA (US); Lakshmi Kumar Dabbiru, Santa Clara, CA (US)

(21) Appl. No.: 18/852,874

(22) PCT Filed: Jun. 16, 2023
(86) PCT No.: PCT/US2023/025560

§ 371 Date: Sep. 30, 2024

(51) Int. Cl. G06T 11/00; G06F 3/04842; G06F 16/9032; G06N 20/00

(52) U.S. Cl. CPC G06T 11/00; G06F 3/04842; G06F 16/90328; G06N 20/00

(57) ABSTRACT

Example embodiments of the present disclosure provide for an example method for prompt element generation for use as input into generative models. The example method includes obtaining user input data including initial prompt data. The example method includes selecting one or more suggested prompt elements based at least in part on the initial prompt data. The example method includes transmitting the one or more suggested prompt elements to be presented for display as selectable user interface elements via a user interface. The example method includes obtaining second user input data including data indicative of a selection of the one or more suggested prompt elements. The example method includes responsive to obtaining the second user input data, providing the second user input to an image generation model to generate an output image including a visual representation associated with the one or more suggested prompt elements.

### FIELD

The present disclosure relates generally to generation of prompt elements for use as input into generative models.

### BACKGROUND

Generative models include machine learning models capable of generating image outputs based on obtained input data. Prompt engineering includes providing better input prompts to receive better than average output from the generative models.

### SUMMARY

Aspects and advantages of embodiments of the present disclosure will be set forth in part in the following description, or can be learned from the description, or can be learned through practice of the embodiments.

In one example aspect, the present disclosure provides for an example computer-implemented method. The example computer-implemented method includes obtaining, by a prompt element suggestion model, from a client device, user input data including initial prompt data. The example computer-implemented method includes selecting, by the prompt element suggestion model, one or more suggested prompt elements based at least in part on the initial prompt data. The example computer-implemented method includes transmitting, by the prompt element suggestion model, to the client device, the one or more suggested prompt elements to be presented for display as selectable user interface elements via a user interface. The example computer-implemented method includes obtaining, by the prompt element suggestion model, from the client device, second user input data including data indicative of a selection of the one or more suggested prompt elements. The example computer-implemented method includes responsive to obtaining the second user input data, providing the second user input to an image generation model to generate an output image including a visual representation associated with the one or more suggested prompt elements.

In some embodiments, the example computer-implemented method includes updating the prompt element suggestion model based on the second user input data.

In some embodiments of the example computer-implemented method, the prompt element suggestion model includes a machine learning language model.

In some embodiments of the example computer-implemented method, the image generation model is configured to perform operations. The computer-implemented method can include generating, based on the obtained second user input data, an output image; performing a validation operation based on the output image; and updating the image generation model based on the performed validation operation.

In some embodiments of the example computer-implemented method, the system includes a prompt element generation component including a machine learning language model configured to generate one or more prompt elements. In some embodiments, generating the suggested prompt elements includes obtaining the initial prompt data and context data; obtaining one or more content elements from a content provider inventory database; and generating, based on the initial prompt data, the context data, and the one or more content elements from the content provider inventory database, one or more prompt elements. In some embodiments, generating the suggested prompt elements includes determining a similarity between a first characteristic associated with a first content element from the content provider inventory database that aligns with the obtained context data; and generating a first prompt element based on the determined similarity and the first content element.

In some embodiments of the example computer-implemented method, the machine learning model to generate the output image includes an image generation model. In some embodiments of the example computer-implemented method, the method includes tuning the image generation model by: providing a training prompt as input to the image generation model; obtaining output including a generated image from the image generation model; comparing the output including the generated image to an approved image associated with the training prompt; and tuning the image generation model based on comparing the output including the generated image to the approved image associated with the training prompt.

In some embodiments of the example computer-implemented method, the one or more suggested prompt elements are generated in real-time.

In some embodiments of the example computer-implemented method, the one or more suggested prompt elements and associated data are stored in a cache.

In some embodiments of the example computer-implemented method, the one or more suggested prompt elements are selected from the cache by determining a distance between the initial prompt data and data associated with one or more prompt elements and associated data stored in the cache; and selecting a first prompt element of the one or more prompt elements and associated data stored in the cache based on the distance between the initial prompt data and the data associated with the first prompt element.

In some embodiments of the example computer-implemented method, the image generation model generates an interactive image including embedded information that when accessed causes the user interface to automatically update with a browser associated with the selected prompt element used as a prompt for the image generation model.

In some embodiments of the example computer-implemented method, selecting, by the prompt element suggestion model, the one or more suggested prompt elements is based on at least one of a quality associated with a suggested prompt element, a relevance of a suggested prompt element, or a ranking of a suggested prompt element.

In some embodiments of the example computer-implemented method, selecting, by the prompt element suggestion model, one or more suggested prompt elements includes determining, based on the obtained initial prompt data, one or more keywords; transmitting a request for data including one or more prompt elements associated with the one or more keywords; and obtaining the one or more prompt elements associated with the one or more keywords.

In some embodiments of the example computer-implemented method, the prompt element suggestion model is a component of an image generation model.

In some embodiments of the example computer-implemented method, the image generation model is a generative machine learning model.

In some embodiments of the example computer-implemented method, the prompt element data includes a token.

In some embodiments of the example computer-implemented method, the selecting, by the prompt element suggestion model, the one or more suggested prompt elements, is performed based at least in part on a bidding process.

In an example aspect, the present disclosure provides for an example system for prompt element generation for use as input in generative models, including one or more processors and one or more memory devices storing instructions that are executable to cause the one or more processors to perform operations. In some implementations, the one or more memory devices can include one or more transitory or non-transitory computer-readable media storing instructions that are executable to cause the one or more processors to perform operations. In the example system, the operations can include obtaining, by a prompt element suggestion model, from a client device, user input data including initial prompt data. In the example system, the operations can include selecting, by the prompt element suggestion model, one or more suggested prompt elements based at least in part on the initial prompt data. In the example system, the operations can include transmitting, by the prompt element suggestion model, to the client device, the one or more suggested prompt elements to be presented for display as selectable user interface elements via a user interface. In the example system, the operations can include obtaining, by the prompt element suggestion model, from the client device, second user input data including data indicative of a selection of the one or more suggested prompt elements. In the example system, the operations can include responsive to obtaining the second user input data, providing the second user input to an image generation model to generate an output image including a visual representation associated with the one or more suggested prompt elements.

In an example aspect, the present disclosure provides for an example transitory or non-transitory computer readable medium embodied in a computer-readable storage device and storing instructions that, when executed by a processor, cause the processor to perform operations. In the example transitory or non-transitory computer-readable medium, the operations include obtaining, by a prompt element suggestion model, from a client device, user input data including initial prompt data. In the example transitory or non-transitory computer-readable medium, the operations include selecting, by the prompt element suggestion model, one or more suggested prompt elements based at least in part on the initial prompt data. In the example transitory or non-transitory computer-readable medium, the operations include transmitting, by the prompt element suggestion model, to the client device, the one or more suggested prompt elements to be presented for display as selectable user interface elements via a user interface. In the example transitory or non-transitory computer-readable medium, the operations include obtaining, by the prompt element suggestion model, from the client device, second user input data including data indicative of a selection of the one or more suggested prompt elements. In the example transitory or non-transitory computer-readable medium, the operations include responsive to obtaining the second user input data, providing the second user input to an image generation model to generate an output image including a visual representation associated with the one or more suggested prompt elements.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system to perform suggesting prompt elements for use as input into a generative model according to example embodiments of the present disclosure;

FIG. 2 depicts a swim lane diagram of an example method to perform suggesting prompt elements for use as input into a generative model according to example embodiments of the present disclosure;

FIG. 3 depicts a flow chart for an example data flow for retrieving and matching prompt elements for use as input into a generative model according to example embodiments of the present disclosure;

FIG. 4 depicts an example database for storing prompt elements and associated keyword data;

FIG. 5 depicts a flow chart for an example data flow for suggesting prompt elements for use as input into a generative model according to example embodiments of the present disclosure;

FIG. 6 depicts a flow chart for training machine models to be fine-tuned to perform suggesting prompt elements for use as input into a generative model according to example embodiments of the present disclosure;

FIG. 7 depicts an example method for suggesting prompt elements for use as input into a generative model according to example embodiments of the present disclosure; and

FIG. 8 depicts a block diagram of an example computing system that performs suggesting prompt elements for use as input into a generative model according to example embodiments of the present disclosure.

### DETAILED DESCRIPTION

The present disclosure provides for improved suggested prompt element data for input into generative models. For instance, the generative models can be image generation models, language models, or groups of models capable of generating images, audiovisual, or other forms of content as output. The present disclosure can include obtaining an initial input provided by a user via a client device and in response, generating one or more suggested prompt elements to present to the user to complete the initially obtained prompt. The suggested prompt element generation models can be trained using a feedback loop by obtaining data associated with the generated output and adjusting the models.

The suggested prompt elements can be generated by a first party computing system that is associated with the generative model or a third-party content provider computing system. The suggested prompt elements can be generated based on content elements or items stored in a content provider database. The suggested prompt elements can be generated in real-time or can be retrieved from a cached storage based on a similarity between the initial input. Some implementations can include a selection process that can include a bidding structure for selecting one or more suggested prompt elements to display to a user. Prompt elements can include tokens, words, selectable elements, or other data used as input into a generative model to create an output content item.

As described herein, a client device can obtain user input data including an initial prompt. The initial prompt can be obtained by the image generation model or a prompt element suggestion component associated with the image generation model. The prompt element suggestion component associated with the image generation model can transmit data including the initial prompt and context data to a prompt element generation system (e.g., content provider prompt element generation system or third-party prompt element generation system). The prompt element generation system can include a prompt element generation model that can generate or otherwise gather one or more suggested prompt elements. The suggested prompt elements can be obtained by the prompt element suggestion component. The prompt element suggestion component can perform a selection process to select one or more prompt elements to transmit to the client device. The selection process can include scoring or ranking the prompt elements.

At the client device, the one or more selected prompt elements can be provided via the image generation application. The image generation application can obtain input including the selection of the one or more selected prompt elements, rejection of one of the one or more selected prompt elements, or more free form input obtained from the user. The prompt element suggestion component can use the refined prompt or other feedback data to train the prompt element suggestion component to make better suggestions moving forward.

The technology of the present disclosure can provide a number of technical effects and benefits. For instance, aspects of the described technology can allow for a reduction in the number of calls made to the generative models by generating higher quality prompts that result in higher quality output produced by the generative models. By recommending prompt elements to a user, the system can reduce processing and errors from incomplete or incorrect prompts. Prompt engineering can be a difficult task and determining the proper prompt to input into a generative model to get out an image or other output that is satisfactory can result in iterative calls to the generative models which can waste processing resources and bandwidth due to redundant calls to the models. The present disclosure can predict an intent of a user based on the initial prompt and context data and can provide suggested prompt elements based on the initial prompt, context data, or additional selection criteria. Additionally, by training and updating the models (e.g., language models, machine learning models, large language models) using a feedback loop, the models can be continually fine-tuned and trained to produce better suggested prompt elements. This can additionally reduce the number of updated prompts a user provides as well as reduce the number of calls made to the image generation model.

The improvements associated with the systems and methods discussed herein can be further understood with reference to the figures.

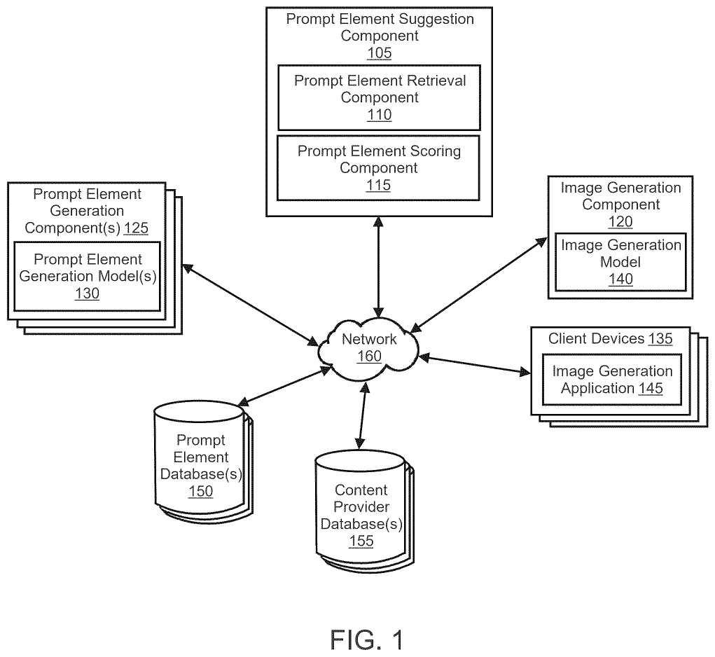

FIG. 1 depicts a block diagram of example system 100 for recommending suggested prompt elements for use as input into a generative model according to example embodiments of the present disclosure. System 100 can include prompt element suggestion component 105, image generation component 120, prompt element generation component(s) 125, client device 135, prompt element database(s) 150, or content provider database(s) communicatively connected over network 160.

Prompt element suggestion component 105 can include prompt element retrieval component 110 or prompt element scoring component 115. Prompt element suggestion component 105 can include one or more models, including for example, a prompt element suggestion model. Prompt element retrieval component 110 can be configured to retrieve one or more suggested prompt elements responsive to receiving a request for a suggested prompt element. Additionally, or alternatively, prompt element retrieval component 110 can be configured to match one or more suggested prompt elements to the initial input data request. The request for the suggested prompt element can be transmitted by client device 135 or image generation component 120. For instance, client device 135 can include image generation application 145. Image generation application 145 can be associated with a graphical user interface that can provide an interactive display via a display of client device 135. Image generation application 145 can obtain user input data via the user interface. The user input data can be transmitted to image generation component 120 or prompt element suggestion component 105 to request one or more related suggested prompt elements. For instance, the image generation application 145 can include a user input component capable of obtaining an initial prompt provided by a user as input for image generation model 140.

As described herein, image generation model 140 can include a language model capable of obtaining user input including the initial prompt, determining an intent associated with the initial prompt, and generating an image based on the obtained initial prompt. In some implementations, the image generation model 140 can include one or more models communicatively coupled to perform the image generation task based on the obtained user input (e.g., initial prompt).

In some instances, the initial prompt data can include data indicative of an image generation application being launched (e.g., a user opening the application, a user beginning an application session). For instance, before a user provides any text or natural language input, the system can perform the methods and operations described herein to suggest or generate prompt element data to be provided for display to a user via the interface associated with the image generation application. In some instances, image generation component 120 can be called upon by other applications to generate images (e.g., communicate with a web-based application, communicate with a social media application, communicate with a search application, or any other application).

Upon receipt of initial user prompt data (e.g., by an interface associated with image generation application 145), client devices 135 can transmit a request for one or more prompt elements to recommend via the image generation application 145 (e.g., to a user). The suggested prompt elements can be obtained by the prompt element suggestion component 105 and transmitted to the client devices 135 to be provided for display as selectable user interface elements.

In some implementations, prompt element retrieval component 110 can obtain prompt elements from prompt element generation component(s) 125, prompt element database(s) 150, or content provider database(s) 155. Prompt element generation component(s) 125 can include one or more prompt element generation components. The prompt element generation component(s) 125 can be associated with a content provider or content management system. The prompt element generation component(s) 125 can include one or more prompt element generation model(s) 130. The prompt element generation models 130 can include one or more models capable of obtaining user input including an initial prompt, determining a user intent, and generating one or more recommended prompt elements. Additionally, or alternatively, prompt element generation model(s) 130 can generate additional data associated with the one or more prompt elements (e.g., keywords, associated data, characteristic data). For instance, prompt element generation model(s) 130 can include generative models capable of obtaining natural language input or other structured input and generating a structured output comprising suggested prompt elements.

Prompt elements can be transmitted to prompt element suggestion component 105 to be used in near-real time or can be transmitted to be stored in a data store, such as prompt element database(s) 150 or content provider database(s) 155. In some implementations, prompt elements can be cached in local storage on a client device 135. Thus, latency can be reduced by performing an on-device selection of suggested prompt elements based on a comparison to the cached prompt elements compared to the initial prompt input data.

Prompt element database(s) 150 can include one or more data stores that can store data including prompt elements and associated prompt element data. For instance, prompt element data can include suggested prompt elements that are generated by prompt element generation component(s) 125. Additionally, or alternatively, prompt element data can include data that is obtained via user input (e.g., by a user associated with content management computing system or content provider computing system). Prompt element data can, additionally or alternatively, include data including keywords associated with the prompt elements or other characteristic data associated with the prompt elements.

Content provider database(s) 155 can include one or more data stores associated with one or more content providers. Content provider database(s) 155 can store content provider data. Content provider data can include content element components, prompt element data (e.g., as discussed with prompt element database(s) 150), content element performance data, or any other relevant content provider data.

Prompt element scoring component 115 can obtain one or more prompt elements. Prompt element scoring component 115 can determine a relevancy of the prompt elements to the initial prompt. The relevancy can be used to generate scores for each of the prompt elements. In some instances a relevancy can be determined based on an analysis by the one or more models of the prompt elements. In some instances, the one or more prompt elements can have a pre-assigned relevancy to certain common initial prompt inputs. In some instances, the relevancy can be determined based on a graph of semantic relationships between terms. The system can compare the candidate prompt elements and the initial prompt input data to the semantic graph to determine a degree of separation between the respective terms. In some instances, the semantic graph can be updated based on data indicative of what suggested prompt elements are ultimately selected by a user and used as input into the image generation model.

Additionally, or alternatively, the prompt elements can be ranked. The prompt element suggestion component 105 can transmit data including the prompt element data to the image generation component 120 or client devices 135. The prompt element data can be obtained by image generation application 145 and can be provided for display via a user interface of the client devices 135. The user interface can obtain data comprising user selection of a prompt and transmit data comprising the updated prompt to the image generation component 120.

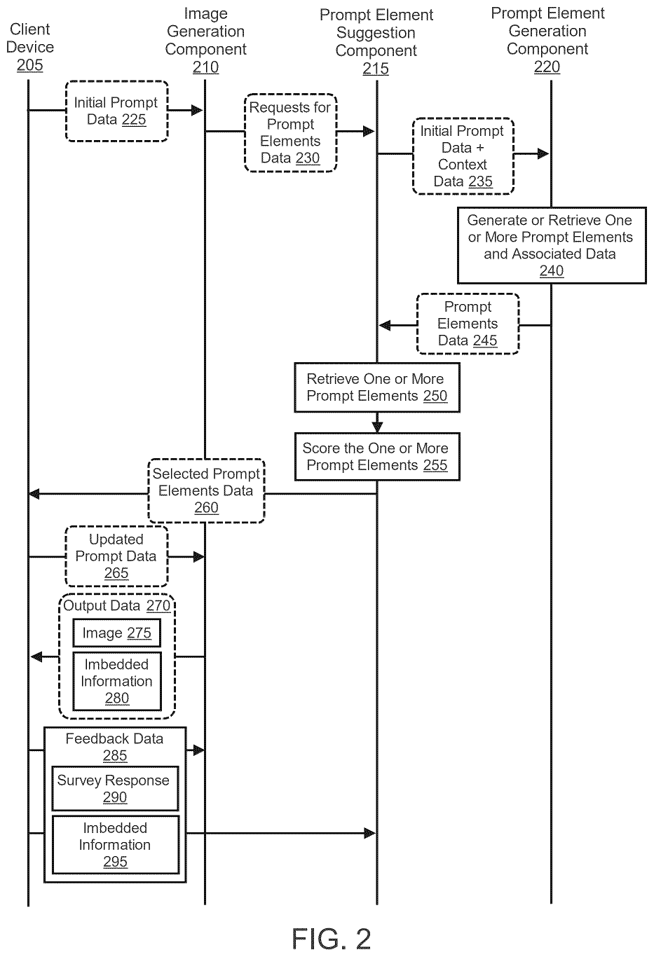

FIGS. 2 to 6 will continue to discuss the flow of data throughout the systems described herein.

FIG. 2 depicts an example swim lane diagram of data flow 200 according to example embodiments of the present disclosure. For instance, data flow 200 can include client device 205, image generation component 210, prompt element suggestion component 215, and prompt element generation component 220.

Initial prompt data 225 can be obtained at client device 205 and transmitted to image generation component 210. Image generation component 210 can generate a request for prompt elements responsive to obtaining the initial prompt data (e.g., automatically). Image generation component 210 can transmit the request for prompt elements 230 to prompt element suggestion component 215. Prompt element suggestion component 215 can obtain the request for prompt elements 230 and transmit data including initial prompt data and context data 235. Context data can be obtained from client device 205, image generation component 210, or prompt element suggestion component 215.

Initial prompt data can include a natural language input, a selection of previously provided prompts, or any other input. In some instances, the input can be provided by a user via a user input component. In some instances, the input can be provided by another computing system or the input can be provided automatically in response to the client device or completing some preliminary action that serves as a trigger for initiating this process. In some instances, initial prompt data can include a natural language indication of what a user would like the image generation component 210 to generate. For instance, a user can provide an initial input of “a cat sitting on a chair” or “a man winning a marathon” or any other input prompt for the image generation component 210 to generate an output image from.

Additionally, or alternatively, a user could be involved in a search session or session with another application. The application, or a model associated with the application, could determine a user intent based on the conversation and automatically initiate the prompt element suggestion pipeline. This can result in a recommendation of not only the suggested prompt elements, but could additionally, or alternatively, provide a recommendation to launch an image generation application or image generation component of another application.

Context data can include data associated with the context of the client device image generation application session. For instance, the context data can include data about previous prompts. In some instances, the image generation component 210 can be one of many language models utilized by a client device. For instance, a user can participate in a session with a singular input component that connects to language models, search models, image generation models, or other generative models that provide output responsive to receipt of a user's input prompt. A user can be guided to a session with the image generation component 210.

For instance, the system can initiate a user session based on obtaining user input indicative of selection of an application to launch. The system can obtain user input including questions about “planning a birthday party,” “designing an invitation,” and “designing graphics for the party.” The models can provide recommendations for the party as well as initiate a session with an image generation model to generate the invitation or graphics for the party.

The image generation component 210 can obtain the context data associated with the session to use in the selection or generation of prompt elements to be suggested to a user for improving the user's input prompt.

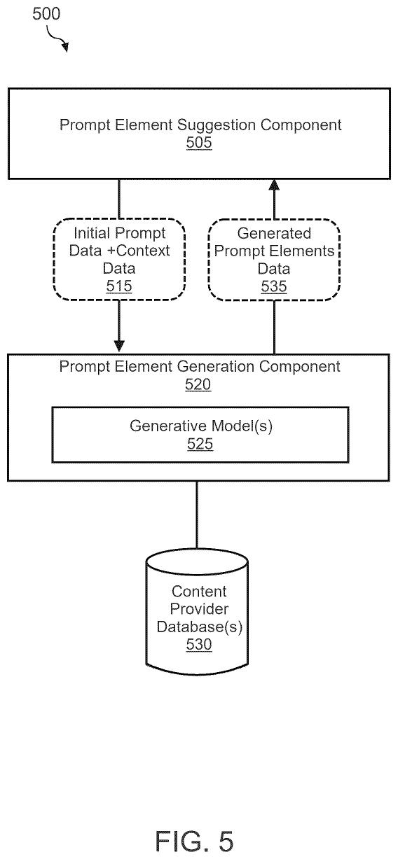

Prompt element generation component 220 can, responsive to obtaining the initial prompt data and context data, generate or retrieve one or more prompt elements and associated data 240. Generating one or more prompt elements will be described in more detail with regard to FIG. 5.

For instance, continuing with the birthday party example, a prompt element generation component 220 can generate or retrieve one or more prompt elements. The prompt elements can be associated with a specific kind of cake that can be purchased at a local bakery or a location for the party such as a local fun park, restaurant, or activity. The prompt elements can have additional associated data (e.g., metadata) that can be invisible to the user, but readable by image generation component 210 to generate one or more images that align with the selected prompt element and associated data.

Prompt elements data 245 can be transmitted from prompt element generation component 220 to prompt element suggestion component 215.

One or more operations can be performed at prompt element suggestion component 215. For example, prompt element suggestion component 215 can retrieve one or more prompt elements 250 or score the one or more prompt elements 255. For instance, prompt element suggestion component 215 can obtain the one or more prompt elements data 245 and determine which prompt elements are most relevant given the initial prompt data and context data 235. In some instances, prompt element suggestion component 215 can score and rank the one or more prompt elements. For instance, the prompt element suggestion component 215 can determine a score for each of the respective prompt elements to determine whether to provide the prompt element as a suggested prompt element (e.g., transmit data that can be read by the client device to provide the suggested prompt elements for display via an interface of the client device 205). In some instances, a plurality of prompt elements can be ranked. The rank of each respective prompt element can be used to determine the order in which to present the ranked prompt elements via the user interface on client device 205.

Selected prompt elements data 260 associated with the one or more suggested prompt elements can be transmitted from prompt element suggestion component 215 to client device 205. Selected prompt element data 260 can include data associated with the one or more selected prompt elements including content to be displayed via a user interface, additional metadata that can be provided for input into the generative model, the score of the respective prompt elements, or other relevant data.

At client device 205, the one or more selected prompt elements can be provided to a user for display. The user can select one or more suggested prompt elements to be used as input into the image generation model of image generation component 210. Updated prompt data 265 indicative of the user selected prompt elements can be transmitted from client device 205 to image generation component 210. For instance, a user can provide input selecting (or rejecting) one or more of the selected prompt elements. The image generation model can obtain data comprising the updated prompt data 265, responsive to obtaining updated prompt data 265, image generation model can automatically generate output. The output can include output data 270 which can be transmitted from image generation component 210 to client device 205. The output data 270 can include an image 275 or embedded information 280. Image 275 can include a graphical depiction of the image generation model's interpretation of the updated prompt data 265.

Returning to the birthday party planning example, the initial prompt can be “an invitation for a birthday party for Jim at 7 PM on Jul. 21, 2023.” The one or more selected prompt elements can be associated with one or more locations or activities in Jim's geographic area. For instance, the selected prompt elements can include an “Italian Restaurant,” a “night club,” an “arcade,” and a “skating rink.” The arcade can be selected and utilized by the user resulting in the generation of updated prompt data. By way of example, the updated prompt could include “Create an invitation for a birthday party for Jim at 7 PM on Jul. 21, 2023, at the arcade. Make the invitation old arcade game themed.” The output data can include an arcade-themed invitation including the date, time, location, and other information. In some instances, the image generation application can include a conversational interface. The conversational interface can allow for follow-up questions to further tailor recommendations and provide improved prompt element suggestions.

Image generation component 210 and prompt element suggestion component 215 can obtain feedback data 285. The feedback data 285 can be utilized by image generation component 210 or prompt element suggestion component 215 to update the respective models associated with the respective components. For instance, feedback data 285 can be used to validate the images generated by image generation component 210. The feedback data 285 can be used to improve the retrieval, matching, scoring, or ranking of the prompt elements by prompt element suggestion component 215.

As described herein, feedback data 285 can include survey response data 290 or refined prompt data 295. For instance, a survey can be provided for display via a user interface on client device 205 or a different client device 205 that can be ranked or scored by a human observer. In some instances, there can be an automatic preliminary check or scoring that rates the satisfaction of the image generated by the image generation model. In some instances, there can be an automatic preliminary check or scoring that rates the satisfaction of the prompt element suggestions that were provided to be used as prompts. In some instances, the computing system can compare the output image to an expected output image from use of the suggested prompt elements previously (e.g., labeled training data). In some instances, the suggested prompt elements can include sponsored or branded content. In some implementations, the feedback system can be set up to determine if the image generated by the image generation component 210 is satisfactory or aligns with brand guidelines of a content provider.

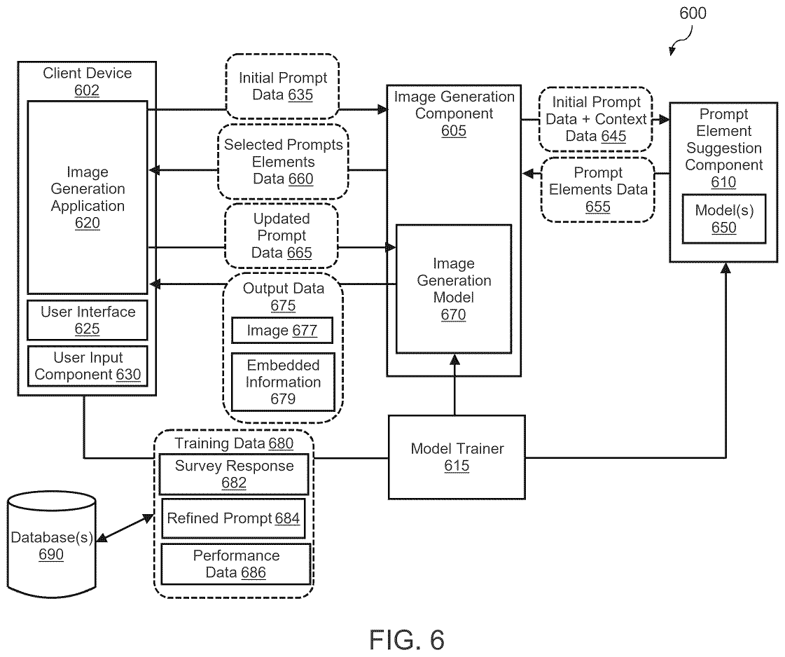

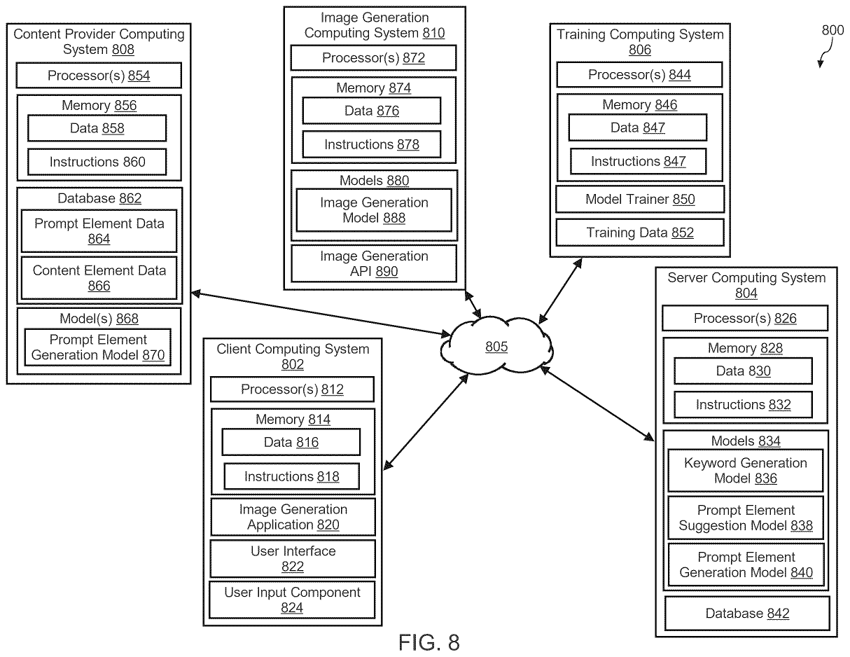

In some instances, satisfaction with a recommended prompt element can be determined based on refined prompt data 295. For instance, if a client device 205 obtains input from a user rejecting the suggested prompt, the system can infer that the suggested prompt is not as relevant to the initial prompt as predicted. This feedback data 285 can be used as training data for personalized models located on client devices or generic models that are located on a server computing system or somehow separated from the client devices. Model training will be described further with regard to FIG. 6 and FIG. 8.

Additionally, or alternatively, the refined prompt data 295 can be obtained after an output image has been displayed via a user interface of client device 205. For instance, the client device can obtain user input including a more detailed prompt, a different prompt from the initial prompt, or a different prompt from the updated prompt. In some implementations, the system can perform a prompt element suggestion process until an indication of user satisfaction is obtained. For instance, the system can continue to provide recommended prompt elements to a user as the user refines the input prompt until the user stops requesting updated images from image generation component 210.

In some implementations, the system can perform a prompt element suggestion process a limited number of times before allowing a user to refine the input prompt. The image generation component 210 can determine a satisfaction score associated with an output image based at least in part on the number of times that a prompt is refined after the initial output image is received. This feedback can be used to train the image generation component 210 to improve the output images generated in future image generation sessions.

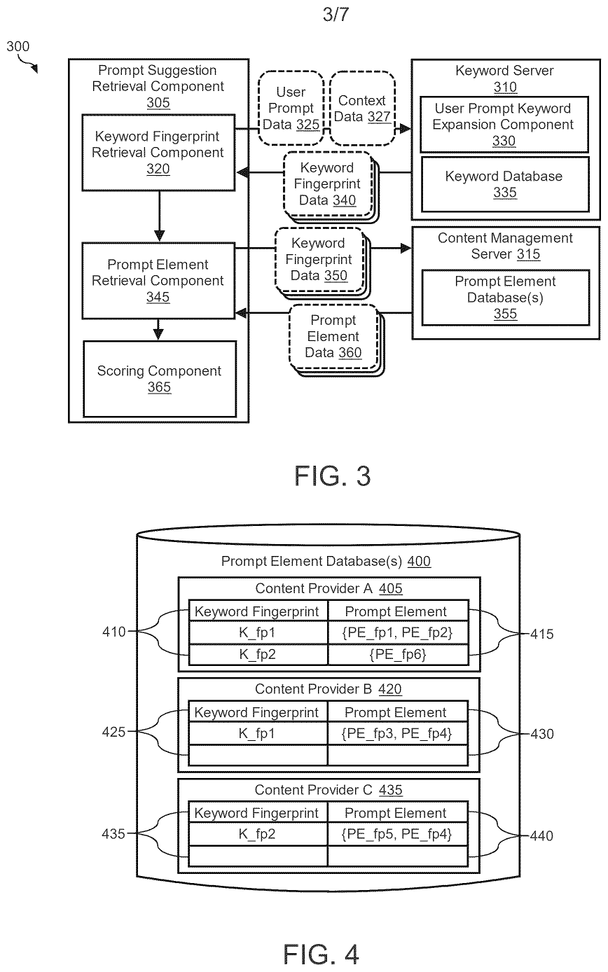

In some implementations, the prompt element suggestion component 215 is part of the image generation component 210. The prompt element suggestion component 215 can perform a plurality of operations. The operations can include those depicted in FIG. 3. For example, FIG. 3 depicts an example data flow 300 for retrieving and matching prompt elements according to example embodiments of the present disclosure. For instance, data flow 300 can include transmitting data from prompt element suggestion component 305, keyword server 310, and content management server 315.

Keyword fingerprint retrieval component 320 can transmit an initial user prompt 325 or context data 327 to keyword server 310. Keyword server 310 can include user prompt keyword expansion component 330 and keyword database 335.

User prompt keyword expansion component 330 can obtain the initial user prompt 325 and context data 327 and determine a plurality of relevant keyword fingerprints to attach to the initial user prompt. In some implementations, the keyword server can be associated with a content provider. In some implementations, the keyword server can be associated with a content management service provider. The initial user prompt 325 and context data 327 can be transmitted as any form of data structure. The data structure can include, for instance, a standard HTTP request framework. For instance, the initial user prompt 325 and context data 327 can be encoded in a data blob using a standard format of {prompt element, keyword value} pairs. In some implementations, standard prompt element templates can be created and stored based on various subject matter and category needs. In some implementations, the subject matter can be associated with different product types (e.g., verticals). The initial user prompt 325 and context data 327 can be partially randomized or otherwise encoded to remove any personal data (e.g., personal identifiable information).

In some instances, the keywords and associated prompts can be stored in keyword database 335. Thus keyword server 310 can generate keywords or otherwise retrieve keywords to be associated with the obtained initial user prompt 325. Keyword server 310 can transmit keyword fingerprint data 340 to keyword fingerprint retrieval component 320. In some implementations, a plurality of content provider server computing systems can provide prompt elements that match the initial user prompt. The pairs of keyword fingerprints and provided prompt elements can be stored in a content management server database (e.g., prompt element database(s) 355) Each prompt element can be stored in a data structure including the prompt element and one or more prompt element fingerprints (e.g., keyword fingerprints).

In some instances, the prompt elements can be stored in the form of a keyval with a key being a keyword fingerprint and the value being a list of prompt element fingerprints that are associated with the keyword fingerprint. Thus the keyword fingerprint retrieval component 320 can obtain a plurality of keyword fingerprints associated with the initial user prompt 325 to be used to parse the prompt element database 355 at content management server 315 to obtain relevant suggested prompt elements.

In some implementations, keyword server 310 can be associated with content management server 315. In some implementations, keyword server 310 can be one or more keyword servers associated with one or more distinct content providers. In some implementations, content providers can include providers of creative assets, advertisers, publishers, artists, or other content providers.

Responsive to keyword fingerprint retrieval component 320 obtaining keyword fingerprint data 340, prompt element retrieval component 345 can initiate the retrieval of prompt elements from content management server 315. Prompt element retrieval component 345 can transmit keyword fingerprint data 350 to a content management server 315. Content management server 315 can obtain the keyword fingerprint data 350 and retrieve one or more relevant prompt elements and associated prompt element data 360 from prompt element database(s) 355. One example prompt element database is depicted in FIG. 400.

Turning to FIG. 4, is a depiction of an example prompt element database 400 (e.g., prompt element database(s) 355). Prompt element database 400 can include prompt element data for a plurality of content providers. For instance, prompt element data can include keyword fingerprint data (e.g., keyword fingerprint 410, 425, and 440) and prompt element data (e.g., prompt element 415, 430, 445). The keyword fingerprint data and prompt element data can be associated with content provider A 405, content provider B 420, or content provider C 435. Due to the structure of prompt element database 400, the content management server 315 can easily locate prompt elements 415, 430, 445 associated with obtained keyword fingerprint data 350.

By way of example, a keyword fingerprint could include a keyword such as “pet.” A prompt element associated with the keyword fingerprint pet could include “Content Provider A's Dog Food” or “Content Provider A's Cat Carrier.” Additional examples can include a keyword of “chair” and prompt elements of specific models of chairs, couches, or other items associated with a content provider that are associated with a keyword “chair.” These examples are provided for illustrative purposes only and are not meant to be limiting.

In some instances, the prompt elements can be provided from one or more content provider servers to the content management server. The prompt elements stored in prompt element database 400 can be matched to an initial user prompt based on the determined keyword fingerprints. In some instances, the initial user prompt can be stored in prompt element database as being associated with the relevant keyword fingerprints. Thus, the prompt element database can be continually updated.

Turning back to FIG. 3, the prompt element data 360 can be transmitted from content management server 315 to prompt element retrieval component 345. Responsive to obtaining the prompt element data 360, prompt element retrieval component 345 can transmit the prompt element data 360 to scoring component 365. For instance, given the obtained initial user prompt 325 and context data 327, one or more keyword fingerprints can be generated. The keyword fingerprints can be used by prompt element retrieval component 345 to retrieve one or more relevant prompt elements. Thus, the input received by the content management server 315 can include one or more keyword fingerprints and associated keyword fingerprint data 350 and the output produced by content management server 315 can include one or more prompt elements and associated prompt element data 360.

Scoring component 365 can obtain the one or more retrieved prompt elements and associated prompt element data 360 and, in response, determine a score for each respective prompt element and rank the respective prompt elements. The score for each respective prompt element can be determined in a number of ways.

In some implementations, the score can be determined as a function of a plurality of quality signals. For instance, the function can be:

$$prompt\_element \_score = f ( CPB , PCTR , PR )$$

Where CPB is a content provider bid, PCTR is a predicted click through rate, and PR is a predicted relevance.

The one or more scored prompt elements can be ranked based on the respective scores. The scoring component 365 can select a top N number of prompt elements to transmit to the client device to be provided for display via a user interface as selectable prompt element suggestions.

The performance of the one or more prompt elements can be determined by the computing system and used to determine predicted click through rate, predicted relevance, or other metrics. For instance, in some implementations, a cost per click can be determined (e.g., using second price auction). The computing system can obtain data indicative of which of the N number of presented suggested prompt elements are selected at the client device. Data associated with the selection (e.g., click) can be reported back via content management server 315 to one or more relevant content providers. The metrics associated with the suggested prompt element performance can be utilized to alter the prompt element retrieval, matching, scoring, or ranking moving forward. In some implementations, the data associated with a plurality of prompt element suggestions can be aggregated and analyzed over time. One or more reports or informative graphics can be provided for display via content provider devices. In some instances, the reports or underlying performance data can be used by the content management server to automatically update bidding strategies associated with the respective content provider's content campaigns. For instance, bids associated with specific prompt elements (e.g., and associated content items or ads) can be updated.

In some instances, the prompt elements can be generated in real time or near-real time. For instance, FIG. 5 depicts an example data flow 500 for generation of one or more prompt elements. By way of example, prompt elements can be generated by a content provider computing system or a content management computing system.

The prompt element suggestion component 505 can transmit the initial prompt data and context data 515 to a prompt element generation component 520. The prompt element generation component 520 can be associated with a content provider or a content management service. In some instances, the prompt element generation component 520 can include one or more generative model(s) 525. The one or more generative models 525 can obtain the initial prompt data and context data 515 as input and generate one or more prompt elements and associated generated prompt elements data 535 as output.

By way of example, prompt element suggestion component 505 can transmit data including initial prompt data and context data 515 to prompt element generation component 520. Prompt element generation component 520 can include one or more generative models 525. The one or more generative models 525 can process the initial prompt data and context data 515 to determine an intent associated with the initial prompt data and context data. The one or more generative models can process the input data to generate one or more prompt elements and generated prompt elements data 535 as output.

In some implementations, the prompt element generation component 520 can be communicatively coupled to content provider database(s) 530. Content provider database(s) 530 can store data associated with content providers. For instance, the data can include data associated with one or more existing prompt elements (e.g., words, phrases, metadata known to produce specific output images when processed by an image generation model, embedded data, links, or other associated data), one or more existing content elements, one or more existing content item campaigns, or other data associated with a content provider. In some implementations, the prompt element generation component 520 can use data from content provider database(s) 530 as input into generative model 525. Generative model 525 can generate one or more prompt elements and associated prompt elements data based on the initial prompt data and context data 515 and data from content provider database(s) 530.

The generated prompt elements data 535 can be transmitted from prompt element generation component 520 and obtained by prompt element suggestion component 505.

FIG. 6 depicts a block diagram of an example feedback loop 600 for training the image generation model 670 or prompt element suggestion component's models 650. For purposes of illustration, FIG. 6 uses the term “training” to describe the feedback loop 600. Please note that the term training is intended to include techniques for customizing the respective models, including, but not limited to, fine-tuning or prompt-tuning. In some implementations, the models described herein can include large language models (LLMs) that are initially trained on large quantities of data. The present disclosure provides for a method for fine-tuning or prompt-tuning the respective models based on obtained user input and other relevant data to allow for the models to become better at performing their respective tasks (e.g., suggesting prompt elements and generating images).

The feedback loop 600 can include client device 602, image generation component 605, prompt element suggestion component 610, and model trainer 615. As described herein, the client device 602 can include an image generation application 620, a user interface 625, and a user input component 603. Client device 602 can obtain input via user input component 630 including initial prompt data 635. In some implementations, the initial prompt data 635 can be obtained by image generation component 605. In some implementations, the initial prompt data 635 can be transmitted alongside context data directly to prompt element suggestion component 610. Image generation component can obtain the initial prompt data 635 via an application programming interface (API). For instance, the API can obtain initial prompt data 635 and generate a data structure that can include initial prompt data and context data. Prompt element suggestion component 610 can obtain data structure including initial prompt data and context data 645 and generate output. The output can include prompt elements data 655.

For instance, prompt element suggestion component 610 can include one or more model(s) 650. The one or more model(s) 650 can be machine learning models. The one or more model(s) 650 can be configured to obtain or generate one or more suggested prompt elements (e.g., through methods described herein). Using the model(s) 650, prompt element suggestion component 610 can generate and transmit prompt elements data 655. Image generation component 605 can obtain the prompt elements data 655 and transmit selected prompt elements data 660 to client device 602. In some instances, prompt element suggestion component 610 can transmit prompt elements data 655 directly to client device 602.

The selected prompt elements data 660 can include instructions, that when executed by the one or more processors of client device 602, cause client device 602 to automatically update the user interface 625 to display the selected prompt elements via user interface 625. For instance, the image generation application 620 can include an interface comprising an input field. As user input is obtained via user input component 630, the system selects the prompt elements to be provided to the user interface 625 to display the suggestions. By way of example, the suggestions can be in the form of a drop-down menu, selectable elements (e.g., buttons), links, or other formats of display. The computing system can obtain data indicative of the user selecting or rejecting one or more suggested prompt elements. The image generation application can facilitate transmission of data including the selection or rejection of the suggested prompt elements by transmitting updated prompt data 665 to image generation model 670 of image generation component 605.

Image generation component 605 can obtain the updated prompt data 665 and generate output data 675 using image generation model 670. Image generation model 670 can include one or more language models configured to generate an output image based on ingestion of a prompt as input into the model. Output data 675 can include image data 677 and embedded information data 679. For instance, the output image can include a generated image that includes an item associated with a content provider (such as a certain brand of shoe on a runner's foot, a specific style of chair). In some implementations, the embedded information 679 can include data that generates a selectable component within the image generation application 620 which is displayed via user interface 625 such that the item associated with the content provider (e.g., certain shoe brand, specific style of chair) can be presented as an interactive user interface element. Responsive to obtaining data including user selection of the interactive user interface element, the user interface 625 of the client device 602 can be automatically updated to provide a website associated with the link or perform some other action based on the embedded information associated with the visual element.

For instance, continuing with the shoe example, a user could select the shoe in the image of a runner finishing a marathon, and responsive to clicking the shoe, a web page where the shoe is available for purchase could be displayed. Additionally, or alternatively, a coupon or some other offer could be provided for display via user interface 625.

In some implementations, a user can provide updated prompt data indicative of a refined prompt. In some instances, image generation application 620 can obtain user input via a survey that is presented to the user. The computing system (e.g., a content management server system) can store data relating to the performance of prior suggested prompt elements or output image data. The performance data (e.g., performance data 686) or other data relating to the prompt element and image performance can be stored in database(s) 690.

Model trainer 615 can use training data 680 to train image generation model 670 or model(s) 650. In some instances, model trainer 615 is part of feedback loop 600. Feedback loop 600 can include obtaining data from client device 602 to use as training data 680. In addition to, or alternatively, training data 680 can include data obtained from one or more database(s) 690.

Training data can include, but is not limited to, survey response data 682, refined prompt data 684, performance data 686, or any other relevant data. Model training will be described further in FIG. 8.

The model(s) 650 can include prompt element generation models that are configured to generate one or more prompt elements. The prompt element suggestion component 610 can access content element performance metrics to update the model(s) 650 to generate prompt elements with better performance. For instance, the content element performance metrics can include clicks, interaction rates, number of impressions, or other performance signals. By continuously updating the model(s) 650 based on the content element performance metrics, the model(s) 650 can continuously improve in functions such as prompt element generation, ranking, scoring, suggesting, or any other prompt element related function.

In some instances, the model trainer 615 can be in a feedback loop 600 with the image generation model 670. For instance, the system can determine that a suggested prompt element has been selected by a user to be used as input into the image generation model 670. Image generation model 670 can generate an output image 677. The output image 677 can be satisfactory to a user or can be unsatisfactory to a user. A user satisfaction can be determined in a number of ways, including, for example, user surveys or a quantitative approach.

Survey response data 682 can be obtained via provision of user surveys. For instance, user surveys can be randomly or otherwise triggered in some instances. By way of example, the user surveys can include one or more questions to determine a performance of the generated images. For instance, the questions can include whether the image generated was relevant to the needs of the user, whether the image met the user's criteria, the quality of the generated image, a request for the image to be ranked on a numerical scale, or other questions relative to the qualitative nature of the generated images. In some instances, images that have been generated based on repeated prompt elements being chosen (e.g., a certain brand of shoe, cat food, furniture, etc.) can be analyzed to determine a quality and a metric indicative of the image satisfying brand guidelines. For instance, there can be an automated process that can determine a quality of a portion of the image associated with a branded element and compare the portion of the image to known satisfactory images associated with the brand. The models can be trained on specific brand related images to improve the image generation model's output. Additionally, or alternatively, the system can determine a number of images to pass on to human review based on determining a difference between the known satisfactory images and the generated images. Thus, the image generation model can be continually fine-tuned to produce improved images.

Refined prompt data 684 can be associated with a quantitative approach to determining performance. For instance, the quantitative approach can determine a performance of the image generation model based on how often refined prompts are obtained via user input after viewing an image generated by using a selected prompt element. For instance, the model trainer 615 can infer that a user providing an updated prompt after viewing the image generated using the suggested prompt element is indicative of the generated image being unsatisfactory to the user. Thus, an increase in the number of follow-up refined prompts (e.g., and a larger volume of refined prompt data 684) can be associated with a need for improvement in the images generated using the suggested prompt elements or an improvement to the suggested prompt elements.

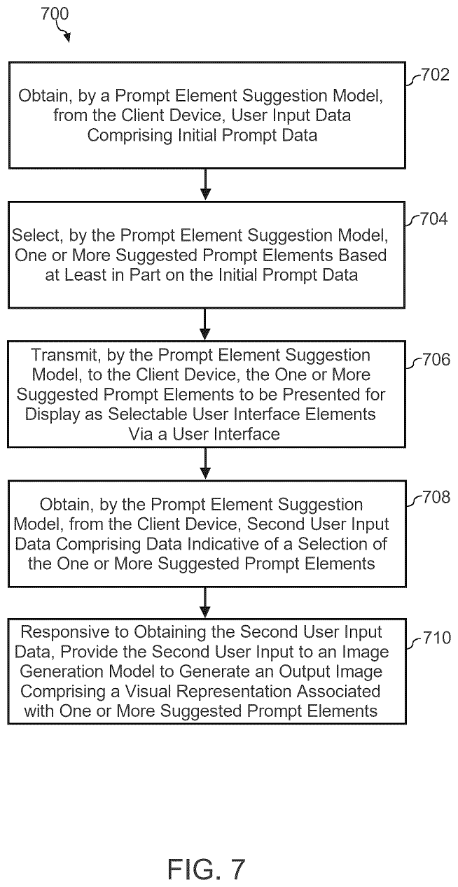

FIG. 7 depicts a flow chart diagram of an example method 700 for prompt element generation for input into generative models. Although FIG. 7 depicts steps performed in a particular order for purposes of illustration and discussion, the methods of the present disclosure are not limited to the particularly illustrated order or arrangement. The various steps of method 700 can be omitted, rearranged, combined, or adapted in various ways without deviating from the scope of the present disclosure.

At (702), method 700 can include obtaining, by a prompt element suggestion model, from a client device, user input data comprising initial prompt data. For instance, a computing system (e.g., computing system 800) can obtain, by a prompt element suggestion model, from a client device, user input data comprising initial prompt data. As described herein, initial prompt data can include a natural language input received via a user input component of a client device. Initial prompt data can be received via a user interface associated with an image generation application located on a user device.

In some instances, prompt element suggestion model can be part of a prompt element suggestion component. For instance, the method can additionally or alternatively include obtaining, by a prompt element suggestion component, from a client device, user input comprising initial prompt data.

For example, the image generation application can be an application where a user provides input into an input field of a desired image to be created. For instance, a user can provide input including “a cat sitting on a chair.” This initial input is fairly broad and could result in a variety of image outputs that may not align with the user's ultimate intent. By way of example, one interpretation of this prompt is a life-sized cat sitting in a life-sized chair. An alternative interpretation of this prompt can be a human sized cat sitting in a human chair or a cat sized cat sitting in a cat-sized chair (or even, perhaps, a cat bed). This disclosure provides for a system to train models to better predict a user's intent and recommend one or more additional prompt elements (e.g., words, phrases, and the like) to bolster the input provided to the image generation model.

In some embodiments, method 700 can include transmitting the initial prompt data and context data to a prompt element generation component. For instance, the computing system can transmit the initial prompt data and context data to a prompt element generation component. The prompt element generation component can include a prompt element generation model. The prompt element generation model can be a machine learning language model (e.g., LLM). As described herein, context data can be data associated with a current user session. For instance, the client device can be associated with a search session or can have other context data associated with the session. For example, the context data can include date or time, location, or other information.

Continuing the example described above, a user session could be indicative of a search to find a chair or other bed for your pet cat. The context can include a previous search session looking into various offerings for cat-sized chairs, cat beds, or other options for a cat's leisure. The initial prompt could be a cat sitting in a chair in my living room. Additionally, for example, the context data could include an uploaded picture of a user's living room.

In some embodiments, method 700 can include obtaining, by the prompt element suggestion component, from the prompt element generation component, one or more suggested prompt elements. For instance, the computing system can obtain, by the prompt element suggestion component, from the prompt element generation component, one or more suggested prompt elements. As described herein, prompt element generation component can include a language model to generate suggested prompt elements. In some instances, method can include a prompt element generation component comprising a machine learning language model configured to generate one or more prompt elements.

In some implementations, generating the suggested prompt elements can include obtaining the initial prompt data and context data. Generating the suggested prompt elements can include obtaining one or more content elements from a content provider database. Generating the suggested prompt elements can include generating, based on the initial prompt data, the context data, and the one or more content elements from the content provider inventory database, one or more prompt elements.

For instance, continuing with our cat sitting in a chair example, the initial user input can be “cat sitting on furniture in my living room” and the context data can include an uploaded photo of the living room. The suggested prompt element component can obtain or generate a plurality of relevant prompt elements. For instance, the system can perform image processing on the input to determine an available open space. The size of the space can be used to help select a prompt element that results in a generated image with a piece of furniture that is the correct size.

In some instances, generating the one or more suggested prompt elements can include determining a similarity between a first characteristic associated with a first content element from the content provider inventory database that aligns with the obtained context data. Generating the one or more suggested prompt elements can include generating a first prompt element based on the similarity. For instance, generating the first prompt element can be based on the determined similarity and the first content element.

By way of example, a characteristic could be an association of “cat” with “pet” and “furniture” with “cat bed,” “scratching post tower,” “cat sized chair” or other similar characteristics. The suggested prompt elements can be selected or generated based on keywords associated with the initial input prompt.

The one or more suggested prompt elements can be generated in real-time, or near real-time. Additionally, or alternatively, the one or more suggested prompt elements and associated data can be stored in a cache. The one or more suggested prompt elements can be selected from the cache. For instance, the method can include determining a distance between the initial prompt data and data associated with the one or more prompt elements and associated data stored in the cache. The method can include selecting a first prompt element of the one or more prompt elements and associated data stored in the cache based on the distance between the initial prompt data and the data associated with the first prompt element. For instance, the associated data can include characteristics, associated keywords, labels, instructions that can be invisible to a user but readable by the image generation model, or other data.

The prompt element suggestion component can include a language model. The prompt element generation component can include an artificial intelligence large language model. Large language models, or LLMs, can include deep learning models that have a large (e.g., order of thousands, millions, or billions) number of parameters that are trained on large volumes of text. LLMs can be utilized to perform a variety of natural language processing (NLP) tasks. The NLP tasks can include, for example, generating text, summarizing text, translating text, generating images, classifying text, answering questions, powering chatbots or virtual assistance, and the like.

The prompt element data can include a token. For instance, a token can include a smaller unit of text that can be processed by a model (e.g., large language models, artificial intelligence large language models). By way of example a token can include a character, a word, a portion of a word, one or more symbols, or some other unit of characters that can be processed as input or generated as output by a model.

At (704), method 700 can include selecting, by the prompt element suggestion model, one or more suggested prompt elements based at least in part on the initial prompt data. For instance, the computing system can select, by the prompt element suggestion model, one or more suggested prompt elements based at least in part on the initial prompt data.

Selecting, by the prompt element suggestion model, the one or more suggested prompt elements can be based on at least one of a quality associated with a suggested prompt element, a relevance of a suggested prompt element, or a ranking of a suggested prompt element.

Selecting, by the prompt element suggestion model, the one or more suggested prompt elements can include determining, based on the obtained initial prompt data, one or more keywords. Selecting, by the prompt element suggestion model, the one or more suggested prompt elements can include transmitting a request for data comprising one or more prompt elements associated with the one or more keywords. Selecting, by the prompt element suggestion model, the one or more suggested prompt elements can include obtaining the one or more prompt elements associated with the one or more keywords.

In some implementations, the prompt element suggestion model can be a component of the image generation model. As described herein, prompt element suggestion model can be a part of prompt element suggestion component. In some implementations, operations described as being performed by the prompt element suggestion model can be performed by the prompt element suggestion component. The image generation model can be a generative machine learning model.

Selecting, by the prompt element suggestion model, the one or more suggested prompt elements can be performed based at least in part on a bidding process. For instance a bidding process can include a dynamic content selection process for determining a content item, or in this example, a prompt element that is appropriate for the current context. For instance, each generated prompt element can have associated data that can include an expected associated output image, associated keywords, or other data that indicates the subject matter or can be used to determine a relevance of the prompt element to a query (e.g., initial prompt data) obtained by the prompt element suggestion component. For instance, a quality score for a plurality of candidate prompt elements can be determined based on a comparison of the initial prompt data and the candidate prompt element data to determine one or more prompt elements with highest scores. In some instances, the prompt elements can include data comprising the word, words, or tokens that will be displayed via the user interface (e.g., an object, a description, etc.). In some instances, the prompt element data can include data that when obtained by the client device (e.g., and the image generation application), can cause a predetermined image to be generated by the image generation model based on the input. For example, a prompt element that displays the following phrase via the user interface “white waterproof running shoe with good support” could be transmitted with additional data that causes company A's shoe to be included in the generated image. In some implementations, the prompt element can relate to historical information, or other information that can be useful to be presented as part of the generated output image.

For instance, returning to the cat example, there can be a plurality of relevant prompt elements available to be recommended. The available prompt elements can include a first prompt element that is “scratching post tower” associated with a first content provider and “cat bed” associated with a second content provider. The prompt element suggestion component can score and rank the available prompt elements and package data associated with them to be transmitted to the client device for display to the user.

At (706), method 700 can include transmitting, by the prompt element suggestion model, to the client device, the one or more suggested prompt elements to be presented for display as selectable user interface elements via a user interface. For instance, the computing system can transmit, by the prompt element suggestion model, to the client device, the one or more suggested prompt elements to be presented for display as selectable user interface elements via a user interface. As described herein, the suggested prompt elements can be presented in a variety of formats. For example, the formats can include a selectable item in a drop-down menu, a selectable button, a prefilled input field, or any other format.

At (708), method 700 can include obtaining, by the prompt element suggestion model, from the client device, second user input data comprising data indicative of a selection of the one or more suggested prompt elements. For instance, the computing system can obtain, by the prompt element suggestion model, from the client device, second user input data comprising data indicative of selection of the one or more suggested prompt elements.

Additionally or alternatively, method 700 can include obtaining, by the prompt element suggestion model, from the client device, second user input data. The second user input data can include at least one of (i) data indicative of a selection of the one or more suggested prompt elements or (ii) updated prompt data. The updated prompt data can include, for example new input data comprising an updated or rephrased input prompt, can include an updated input prompt relating to a completely new subject matter, or can include some other update to the input prompt.

In some implementations, method 700 can include updating the prompt element suggestion model based on the second user input data. For instance, the method can include obtained user input data comprising the selection of one of the recommended prompt elements.

At (710), method 700 can include, responsive to obtaining the second user input data, providing the second user input to an image generation model to generate an output image comprising a visual representation associated with the one or more suggested prompt elements. For instance, the computing system can, responsive to obtaining the second user input data, providing the second user input to an image generation model to generate an output image comprising a visual representation associated with the one or more suggested prompt elements. As described herein, the output generated by the image generation model can include image data, audio data, audiovisual data, or any other type of output that can be displayed via client device.

In some implementations, method 700 includes the image generation model configured to perform operations. The operations can include generating, based on the obtained second user input data, an output image. The operations can include performing a validation operation based on the output image. The operations can include updating the image generation model based on the performed validation operation.

The image generation model can generate an interactive image including embedded information. The embedded information can be information that, when accessed, causes the user interface to automatically update with a browser associated with the selected prompt element used as a prompt for the image generation model.

For instance, the client device can obtain data indicative of the user selecting the “cat bed” recommended prompt element. The “cat bed” recommended prompt element can have additional associated embedded data such that, when the image is generated that includes “a cat in a cat bed in my living room,” an image of a cat sitting on the relevant cat bed in the provided living room is generated. The image generated can include embedded content such that when the image is selected by a user, or a portion of the image (e.g., the cat bed) is selected, the user interface is updated and redirected to a website associated with the cat bed.

Method 700 can include training or tuning the image generation model. For instance, the image generation model can be a machine learning model. Method 700 can include tuning the image generation model. Tuning the image generation model can include providing a training prompt as input into the image generation model. Tuning the image generation model can include obtaining output comprising a generated image from the image generation model. Tuning the image generation model can include comparing the output comprising the generated image to an approved image associated with the training prompt. Tuning the image generation model can include tuning the image generation model based on comparing the output comprising the generated image to the approved image associated with the training prompt. For instance, various weights and parameters associated with the models can be adjusted to improve the outputs of the models. In some instances, the image generation model can be trained or tuned to predict known portions of output image based on the data associated with the second user prompt data. For instance, the second user prompt data can include a selected prompt element. The selected prompt element can have associated data that provide additional input information to the model (e.g., that is not displayed to the user via the user interface) but is ingested by the image generation model to result in a known portion of an output image (e.g., a specific shoe, a specific physical article presented within the image, and the like).

In some instances, the prompt element suggestion component or prompt element suggestion model can be a component of the image generation model. In some instances, the prompt element suggestion component can be communicatively coupled to the image generation model. The image generation model can be a generative machine learning model. In some instances, the image generation model can be a group of models with distinct functions that work together to process an obtained input prompt and generate an image to provide for display.

While FIG. 7 describes an implementation of utilizing an image generation model, the described method can be applied to any generative model capable of obtaining input prompt data and producing an output based on the obtained input prompt data.

FIG. 8 depicts a block diagram of an example computing system 800 that performs prompt generation and recommendations for input into generative models to improve the output of the generative models according to example embodiments of the present disclosure.

The computing system 800 includes a client computing system 802, a server computing system 804, a training computing system 806, a content provider computing system 808, and an image generation computing system 810 that are communicatively coupled over a network 805.

The client computing system 802 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The client computing system 802 includes one or more processors 812 and a memory 814. The one or more processors 812 can be any suitable processing device (e.g., a processor core, a microprocessor, an ASIC, an FPGA, a controller, a microcontroller, etc.) and can be one processor or a plurality of processors that are operatively connected. The memory 814 can include one or more non-transitory computer-readable storage media, such as RAM, ROM, EEPROM, EPROM, flash memory devices, magnetic disks, etc., and combinations thereof. The memory 814 can store data 816 and instructions 818 which are executed by the processor 812 to cause the client computing system 802 to perform operations.

In some implementations, the client computing system 802 can include image generation application 820. Image generation application 820 can include an application that is downloaded on a user device. Additionally, or alternatively, image generation application 820 can include a web-based application. Image generation application 820 can communicate with an application programming interface (e.g., image generation API 890) to interface with image generation computing system 810. For instance, the API can facilitate interaction between client computing system 802, server computing system 804, and image generation computing system 810.

In some implementations, the client computing system can include a user interface 822. The user interface 822 can include a graphical user interface, audio user interface, touch user interface, or any other user interface. The client computing system can include a user input component 824. The user input component 824 can be associated with user interface 822 and can be capable of obtaining user input. For instance, user input can include touch, audio, or other user input. In some instances, user input component 824 can be capable of obtaining user input and translating the user input into a computer readable form.

The server computing system 804 includes one or more processors 826 and a memory 828. The one or more processors 826 can be any suitable processing device (e.g., a processor core, a microprocessor, an ASIC, an FPGA, a controller, a microcontroller, etc.) and can be one processor or a plurality of processors that are operatively connected. The memory 828 can include one or more non-transitory computer-readable storage media, such as RAM, ROM, EEPROM, EPROM, flash memory devices, magnetic disks, etc., and combinations thereof. The memory 828 can store data 830 and instructions 832 which are executed by the processor 826 to cause the server computing system 804 to perform operations.

In some implementations, the server computing system 804 includes or is otherwise implemented by one or more server computing devices. In instances in which the server computing system 804 includes plural server computing devices, such server computing devices can operate according to sequential computing architectures, parallel computing architectures, or some combination thereof.

Server computing system 804 can be configured to obtain data from client computing system 802 (e.g., via image generation application 820). For instance, server computing system 804 can utilize the obtained user input data to update or train one or more models 834 (e.g., keyword generation model 836, prompt element suggestion model 838, prompt element generation model 840).

As described above, the server computing system 804 can store or otherwise include one or more models 834 (e.g., keyword generation model 836, prompt element suggestion model 838, prompt element generation model 840). For example, the models 834 (e.g., keyword generation model 836, prompt element suggestion model 838, prompt element generation model 840) can be or can otherwise include various statistical or machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Models 834 can include keyword generation model 836, prompt element suggestion model 838, and prompt element generation model 840. Keyword generation model 836 can generate keywords for an initial prompt obtained by a user to determine one or more relevant keywords to be used to retrieve or generate suggested prompt elements. Prompt element suggestion model 838 can retrieve, score, or rank one or more obtained prompt elements. Prompt element generation model 840 can be configured to generate one or more prompt elements. Example prompt element suggestion model 838 can include a prompt element generation model. The prompt element suggestion model 838's prompt element generation model and prompt element generation model 840 are discussed with reference to FIG. 5 and FIG. 6.

Server computing system 804 can include database 842. Database 842 can store historic signal data. Historic signal data can include previously acquired signal data associated with previously rendered prompt elements or generated images obtained from image generation computing system, content provider computing system 808, or server computing system 804.

The content provider computing system 808 includes one or more processors 854 and a memory 856. The one or more processors 854 can be any suitable processing device (e.g., a processor core, a microprocessor, an ASIC, an FPGA, a controller, a microcontroller, etc.) and can be one processor or a plurality of processors that are operatively connected. The memory 856 can include one or more non-transitory computer-readable storage media, such as RAM, ROM, EEPROM, EPROM, flash memory devices, magnetic disks, etc., and combinations thereof. The memory 856 can store data 858 and instructions 860 which are executed by the processor 854 to cause the content provider computing system 808 to perform operations.

In some implementations, the content provider computing system 808 includes or is otherwise implemented by one or more server computing devices. In instances in which the content provider computing system 808 includes plural server computing devices, such server computing devices can operate according to sequential computing architectures, parallel computing architectures, or some combination thereof.

Content provider computing system 808 can include database 862. Database 862 can store prompt element data 864 and content element data 866. Prompt element data 865 can include prompt elements, keyword values, or other characteristic data associated with prompt elements. Content element data 866 can include content elements, asset groups, or other content related data.

Content provider computing system 808 can be communicatively connected over network 805 to server computing system 804. In some instances, content provider computing system 808 can be a first party computing system associated with the server computing system 804. In some instances, content provider computing system 808 can be associated with a third-party content provider (e.g., advertiser). There can be more than one content provider computing system 808.

As described above, the content provider computing system 808 can store or otherwise include one or more models 868 (e.g., prompt element generation model 870). For example, the models 868 (e.g., prompt element generation model 870) can be or can otherwise include various statistical or machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Models 868 can include prompt element generation model 870. Prompt element generation model 870 can be configured to generate one or more prompt elements. Example prompt element generation model 870 is discussed with reference to FIG. 5 and FIG. 6.

The image generation computing system 810 includes one or more processors 872 and a memory 874. The one or more processors 872 can be any suitable processing device (e.g., a processor core, a microprocessor, an ASIC, an FPGA, a controller, a microcontroller, etc.) and can be one processor or a plurality of processors that are operatively connected. The memory 874 can include one or more non-transitory computer-readable storage media, such as RAM, ROM, EEPROM, EPROM, flash memory devices, magnetic disks, etc., and combinations thereof. The memory 874 can store data 876 and instructions 878 which are executed by the processor 872 to cause the image generation computing system 810 to perform operations.

In some implementations, the image generation computing system 810 includes or is otherwise implemented by one or more server computing devices. In instances in which the image generation computing system 810 includes plural server computing devices, such server computing devices can operate according to sequential computing architectures, parallel computing architectures, or some combination thereof.

As described above, the image generation computing system 810 can store or otherwise include one or more models 880 (e.g., image generation model 888). For example, the models 880 (e.g., image generation model 888) can be or can otherwise include various statistical or machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Models 880 can include image generation model 888. Image generation model 888 can be configured to generate one or more images or other generated output. Example image generation model 888 is discussed with reference to FIG. 5 and FIG. 6.

The client computing system 802 or the server computing system 804 can train the models 834, 868, 880 via interaction with the training computing system 806 that is communicatively coupled over the network 805. The training computing system 806 can be separate from the server computing system 804 or can be a portion of the server computing system 804.

The training computing system 806 includes one or more processors 844 and a memory 846. The one or more processors 844 can be any suitable processing device (e.g., a processor core, a microprocessor, an ASIC, an FPGA, a controller, a microcontroller, etc.) and can be one processor or a plurality of processors that are operatively connected. The memory 846 can include one or more non-transitory computer-readable storage media, such as RAM, ROM, EEPROM, EPROM, flash memory devices, magnetic disks, etc., and combinations thereof. The memory 846 can store data 847 and instructions 848 which are executed by the processor 844 to cause the training computing system 806 to perform operations. In some implementations, the training computing system 806 includes or is otherwise implemented by one or more server computing devices.

The training computing system 806 can include a model trainer 850 that trains the machine-learned models 840, 868, 880 stored at the client computing system 802, the server computing system 804, the content provider computing system 808, or the image generation computing system 810 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, or various other loss functions. Gradient descent techniques can be used to iteratively update the parameters over a number of training iterations.

In some implementations, performing backwards propagation of errors can include performing truncated backpropagation through time. The model trainer 850 can perform a number of generalization techniques (e.g., weight decays, dropouts, etc.) to improve the generalization capability of the models being trained.

In particular, the model trainer 850 can train the models 840, 868, 880 based on a set of training data 852. The training data 852 can include, for example, can include historic signal data, publisher-rendered native content item data, user input data, conversion data, user device location data, click data, or any other relevant data (e.g., data stored in database 842, data stored in database 862, and the like).

In some implementations, if the user has provided consent, the training examples can be provided by the client computing system 802. Thus, in such implementations, the models 834, 861, 880 provided to the client computing system 802 can be trained by the training computing system 806 on user-specific data received from the client computing system 802. In some instances, this process can be referred to as personalizing the model.

The model trainer 850 includes computer logic utilized to provide desired functionality. The model trainer 850 can be implemented in hardware, firmware, or software controlling a general purpose processor. For example, in some implementations, the model trainer 850 includes program files stored on a storage device, loaded into a memory and executed by one or more processors. In other implementations, the model trainer 850 includes one or more sets of computer-executable instructions that are stored in a tangible computer-readable storage medium such as RAM, hard disk, or optical or magnetic media.

The network 805 can be any type of communications network, such as a local area network (e.g., intranet), wide area network (e.g., Internet), or some combination thereof and can include any number of wired or wireless links. In general, communication over the network 805 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may be used in a variety of tasks, applications, or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 8 illustrates one example computing system that can be used to implement the present disclosure. Other computing systems can be used as well. For example, in some implementations, the client computing system 802 can include the model trainer 850 and the training data 852. In such implementations, the models 834, 868, 880 can be both trained and used locally at the client computing system 802. In some of such implementations, the client computing system 802 can implement the model trainer 850 to personalize the models 834, 868, 880 based on user-specific data.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted or described steps are merely illustrative and can be omitted, combined, or performed in an order other than that depicted or described; the numbering of depicted steps is merely for ease of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform particular tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skill in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

1. A computer-implemented method, comprising:
obtaining, by a prompt element suggestion model, from a client device, user input data comprising initial prompt data;
selecting, by the prompt element suggestion model, one or more suggested prompt elements based at least in part on the initial prompt data;
transmitting, by the prompt element suggestion model, to the client device, the one or more suggested prompt elements to be presented for display as selectable user interface elements via a user interface;
obtaining, by the prompt element suggestion model, from the client device, second user input data comprising data indicative of a selection of the one or more suggested prompt elements; and
responsive to obtaining the second user input data, providing the second user input to an image generation model to generate an output image comprising a visual representation associated with the one or more suggested prompt elements.

2. The computer-implemented method of claim 1, comprising:
updating the prompt element suggestion model based on the second user input data.

3. The computer-implemented method of claim 1,
wherein the prompt element suggestion model comprises a machine learning language model.

4. The computer-implemented method of claim 1, wherein the image generation model is configured to perform operations comprising:
generating, based on the obtained second user input data, an output image;
performing a validation operation based on the output image; and
updating the image generation model based on the performed validation operation.

5. The computer-implemented method of claim 1, comprising a prompt element generation component comprising a machine learning language model configured to generate one or more prompt elements.

6. The computer-implemented method of claim 5, wherein generating the suggested prompt elements comprises:
obtaining the initial prompt data and context data;
obtaining one or more content elements from a content provider inventory database; and
generating, based on the initial prompt data, the context data, and the one or more content elements from the content provider inventory database, one or more prompt elements.

7. The computer-implemented method of claim 6, wherein generating the one or more prompt elements comprises:
determining a similarity between a first characteristic associated with a first content element from the content provider inventory database that aligns with the obtained context data; and
generating a first prompt element based on the determined similarity and the first content element.

8. The computer-implemented method of claim 1, comprising:
tuning the image generation model by:
providing a training prompt as input to the image generation model;
obtaining output comprising a generated image from the image generation model;
comparing the output comprising the generated image to an approved image associated with the training prompt; and
tuning the image generation model based on comparing the output comprising the generated image to the approved image associated with the training prompt.

9. The computer-implemented method of claim 1, wherein the one or more suggested prompt elements are generated in real-time.

10. The computer-implemented method of claim 1, wherein the one or more suggested prompt elements and associated data are stored in a cache.

11. The computer-implemented method of claim 10, wherein the one or more suggested prompt elements are selected from the cache by:
determining a distance between the initial prompt data and data associated with one or more prompt elements and associated data stored in the cache; and
selecting a first prompt element of the one or more prompt elements and associated data stored in the cache based on the distance between the initial prompt data and the data associated with the first prompt element.

12. The computer-implemented method of claim 4, wherein the image generation model generates an interactive image comprising embedded information that when accessed causes the user interface to automatically update with a browser associated with the selected prompt element used as a prompt for the image generation model.

13. The computer-implemented method of claim 1, wherein selecting, by the prompt element suggestion model, the one or more suggested prompt elements is based on at least one of a quality associated with a suggested prompt element, a relevance of a suggested prompt element, or a ranking of a suggested prompt element.

14. The computer-implemented method of claim 1, wherein selecting, by the prompt element suggestion model, one or more suggested prompt elements comprises:
determining, based on the obtained initial prompt data, one or more keywords;
transmitting a request for data comprising one or more prompt elements associated with the one or more keywords; and
obtaining the one or more prompt elements associated with the one or more keywords.

15. The computer-implemented method of claim 1, wherein the prompt element suggestion model is a component of an image generation model.

16. The computer-implemented method of claim 15, wherein the image generation model is a generative machine learning model.

17. The computer-implemented method of claim 1, wherein the prompt element data comprises a token.

18. The computer-implemented method of claim 1, wherein the selecting, by the prompt element suggestion model, the one or more suggested prompt elements, is performed based at least in part on a bidding process.

19. A computing system, comprising:
one or more processors; and
one or more non-transitory computer-readable media storing instructions that are executable to cause the one or more processors to perform operations, the operations comprising:
obtaining, by a prompt element suggestion model, from a client device, user input data comprising initial prompt data;
selecting, by the prompt element suggestion model, one or more suggested prompt elements based at least in part on the initial prompt data;
transmitting, by the prompt element suggestion model, to the client device, the one or more suggested prompt elements to be presented for display as selectable user interface elements via a user interface;
obtaining, by the prompt element suggestion model, from the client device, second user input data comprising data indicative of a selection of the one or more suggested prompt elements; and
responsive to obtaining the second user input data, providing the second user input to an image generation model to generate an output image comprising a visual representation associated with the one or more suggested prompt elements.

20. One or more non-transitory computer readable media storing instructions that are executable by one or more processors to perform operations comprising:
obtaining, by a prompt element suggestion model, from a client device, user input data comprising initial prompt data;
selecting, by the prompt element suggestion model, one or more suggested prompt elements based at least in part on the initial prompt data;
transmitting, by the prompt element suggestion model, to the client device, the one or more suggested prompt elements to be presented for display as selectable user interface elements via a user interface;
obtaining, by the prompt element suggestion model, from the client device, second user input data comprising data indicative of a selection of the one or more suggested prompt elements; and
responsive to obtaining the second user input data, providing the second user input to an image generation model to generate an output image comprising a visual representation associated with the one or more suggested prompt elements.
